(19) United States
(12) Patent Application Publication
(10) Pub. No.: US 2019/0221964 A1
(43) Pub. Date: Jul. 18, 2019

(54) ELECTRICAL CONNECTING LINE AND USE THEREOF

(71) Applicant: SIEMENS MOBILITY GMBH, Muenchen (DE)

(72) Inventor: Klaus PATZELT, PETERSHAUSEN (DE)

(21) Appl. No.: 16/307,007

(22) PCT Filed: Jun. 1, 2017
(86) PCT No.: PCT/EP2017/063242

§ 371 Date: Dec. 4, 2018

(30) Foreign Application Priority Data
Jun. 10, 2016 (DE) 102016210323.7

(51) Int. Cl. H01R 13/58; H01R 11/12; H01R 4/14; H01R 4/64; H01R 4/30

(52) U.S. Cl. CPC H01R 13/5833; H01R 11/12; H01R 4/308; H01R 4/64; H01R 4/14

(57) ABSTRACT

A rail vehicle includes an electrical connecting line being a rail vehicle earthing line. The electrical connecting line has one end constructed as at least one loop in order to provide the connecting line with a high mechanical load capacity. The at least one loop has two loop ends forming another end of the connecting line. A fastening apparatus is disposed at the one end of the connecting line. A method for earthing a rail vehicle having an electric earthing line is also provided.

### BACKGROUND OF THE INVENTION

### Field of the Invention

It is known to provide an electrical connecting line with a fastening apparatus on the end thereof, which fastening apparatus is often a cable shoe that is connected to the electrical line in the manner of a crimp connection. In this case, a normal cable shoe is designed for a maximum temperature of around 100° C. At higher temperatures, oxidation and strength problems occur.

Oxidation problems can be overcome using nickel coatings or greasing, making it possible to achieve temperature limits of 150° C. or 200° C.

Strength problems arise on account of the fact that, in particular in the event of a short-circuit current through the electrical line, high pull-off forces occur that may inadvertently cut the connection between the electrical line and the cable shoe. Namely, it has been found that the copper material normally used for the electrical connecting line flows at higher temperatures, such that the pull-off forces originally present are not able to be maintained over time. Namely, with a temperature increase of 20° C. to 150° C., the modulus of elasticity of copper reduces by about half.

Furthermore, it is known to use stranded wires as electrical connecting lines and to press them using ferrules; however, such press connections do not achieve such high pull-off forces as in the case of crimp connections.

It would also be possible to consider soldering the electrical connecting lines to ferrules, but in this case as well the pull-off forces are not high enough to securely connect earthing ropes in the event of a short-circuit current, for example.

It is known from the Internet publication ‘https://de.wikipedia.org./wiki/Kabelschuh’ to use crimping rings for the screwed fastening of stranded lines, in which the strand is inlaid in annular form. A similar fastening solution is also disclosed in U.S. Pat. No. 4,315,188 A.

German laid open specification DE 10 2012 223 766 A discloses a motor vehicle having an energy storage arrangement and a connecting line having a loop.

The invention lies in the field of rail vehicle technology and relates to the improvement of rail vehicles.

### SUMMARY OF THE INVENTION

According to the invention, a rail vehicle having the features according to claim 1 is provided. One significant advantage of the inventive refinement of the connecting or earthing line is that it is also able to be exposed to high loads, because the strength of this connecting line with the fastening apparatus is limited only by the tearing forces of the connecting line itself and the durability of the fastening apparatus, wherein both the tearing forces of the connecting line and the durability of the fastening apparatus should be considered to be very high.

The connecting line may be configured in various ways at its other end facing away from its one end. Thus, in the event of temperature loading that is not very high, it may be sufficient for the connecting line, in the case of a loop in the region of the fastening apparatus, to be fastened, for example crimped, clamped, welded or pressed, to its loop ends. The loop ends may be fastened to one another at various points.

However, it is considered to be particularly advantageous if the connecting line forms a further loop at its other end in the region of a further fastening apparatus. In this way, both ends of the connecting line are able to be mechanically loaded to a great extent, such that this embodiment of the connecting line is also preferably able to be used in earthing lines, as are able to be used for example in electric locomotives.

In this case, the further loop may connect the loop ends of the one loop to one another at the other end of the connecting line, such that the connecting line is designed to be endless. A current through the connecting line between the two fastening apparatuses is then distributed evenly in two branches of identical size, such that the line cross section is doubled.

It may also be advantageous, however, if the further loop continues as an additional loop within the one fastening apparatus. This results in a line cross section that is three times larger than in the case of a single connecting line between the two fastening apparatuses.

If the additional loop in the one fastening apparatus extends as far as the further fastening apparatus in the connecting line, then a winding having two turns is thus achieved that is distinguished by expedient current distribution. In addition, even more turns may be formed in the manner described.

In the connecting line, the fastening apparatus may be formed in various ways; it is deemed to be particularly advantageous if the fastening apparatus and the further fastening apparatus respectively consist of two conductive plates between each of which the loops are fastened.

It is furthermore considered to be advantageous, in the connecting line, if mutually flush bores for receiving a fastening bolt are provided in the conductive plates of each fastening apparatus, around which fastening bolts the loops are guided. As a result, the strength of the electrical connecting line is determined by the high strength of the bolt. The fastening bolt is also important for traction.

In one advantageous embodiment of the connecting line, the conductive plates of the fastening apparatuses are each designed contiguously in a U-shape, which has an advantageous effect in terms of manufacturing.

Furthermore, an embodiment of the connecting line in which the conductive plates of the fastening apparatuses are each designed contiguously in a tubular shape also proves advantageous. This embodiment of the fastening apparatuses is also expedient in terms of manufacturing.

The connecting line furthermore advantageously makes it possible in each case to produce the conductive plates and the loops respectively received by them by way of a crimp connection, because this is a method used for connecting electrical connecting lines to cable shoes; clamping, welding or pressing may also be considered, however.

Various materials may be used as electrical connecting line; a connecting line made from a rigid conductor or from strands may thus be used. Furthermore, the electrical connecting line may preferably consist of a flat-band conductor or of a round material.

It is advantageous if a current, in particular a short-circuit current, flowing from the other end of the connecting line through the connecting line flows through the two loop ends to the fastening apparatus. As an alternative, the current may also flow in the reverse direction.

The loop, in its bent region, is preferably positioned in the fastening apparatus and/or fastened to the fastening apparatus.

At the other end of the connecting line, the two loop ends of the loop are preferably positioned in a further fastening apparatus and/or fastened to a further fastening apparatus.

In one advantageous variant, it is provided that the connecting line forms a further loop at its other end in the region of a further fastening apparatus.

The further loop, in its bent region, is preferably positioned in the further fastening apparatus and/or fastened to the further fastening apparatus.

In one advantageous variant, it is provided that the further loop connects the loop ends of the one loop to one another.

In another advantageous variant, it is provided that one loop end of the further loop adjoins a loop end of the one loop and the other loop end of the further loop adjoins a loop end of an additional loop.

It is also advantageous if a bent region of the additional loop is positioned at the one end of the connecting line in the one fastening apparatus and/or fastened to the one fastening apparatus.

The connecting line may be used in various ways. One particular advantage is seen in its use in the case of an earthing line, because such an earthing line is exposed to high forces by way of transient high currents.

One particularly advantageous use of the electrical connecting line is seen in the case of hot connection points of an earthing rope (for example in the case of an electric locomotive).

### BRIEF DESCRIPTION OF THE SEVERAL VIEWS OF THE DRAWING

To further explain the invention, in the figures:

FIG. 1 shows a longitudinal section of an exemplary embodiment of a basic form of the connecting line provided according to the invention,

FIG. 2 shows a cross section through the exemplary embodiment according to FIG. 1, and

FIG. 3 schematically shows an electrical connecting line having two fastening apparatuses at its ends.

### DETAILED DESCRIPTION OF THE INVENTION

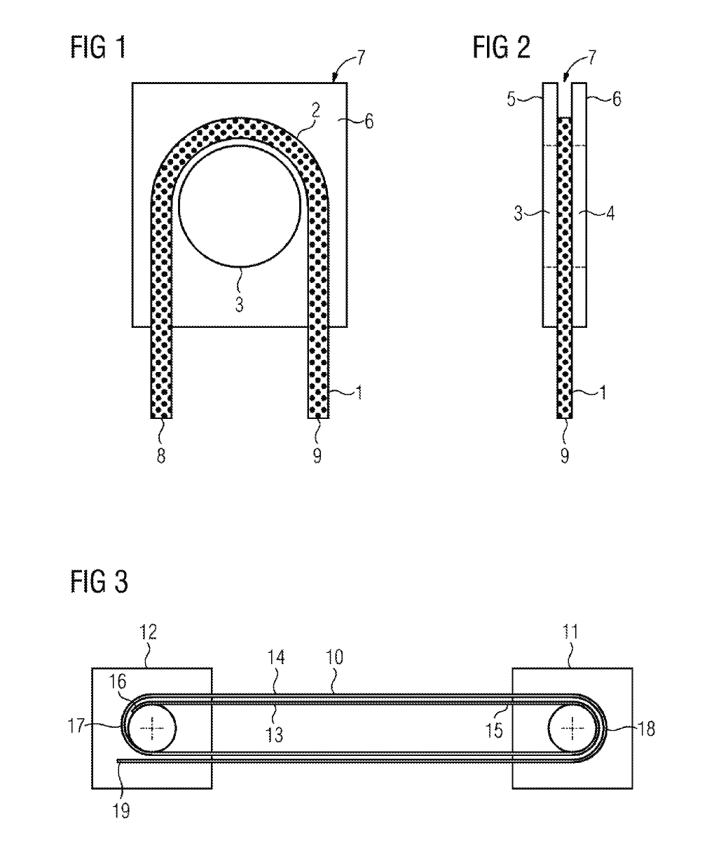

FIGS. 1 and 2 show an electrical connecting line 1, which is guided as a loop 2 around mutually flush bores 3 and 4 in conductive plates 5 and 6 of a fastening apparatus 7; the fastening apparatus 7 forms an end of the electrical connecting line 1. The loop 2 may for example be positioned between the conductive plates 3 and 4 by way of a crimp connection. The bores 3 and 4 are passed through by a fastening bolt, this not being shown in more detail, by way of which the fastening apparatus 7 is able to be fastened to an electrical arrangement, for example as an earthing line, not shown.

Loop ends 8 and 9 of the loop 2 may be connected to a further part of the arrangement, not shown, in various ways, for example by a crimp, press or clamp connection; the loop ends 8 and 9 form another end of the electrical connecting line 1. It should be highlighted that a current, in particular a short-circuit current, flowing through the connecting line 1 flows through both loop ends 8 and 9 to the one fastening apparatus 7.

In the exemplary embodiment according to FIG. 3, an electrical connecting line 10 is shown that extends between a fastening apparatus 11 and a further fastening apparatus 12; each of the two fastening apparatuses 11 and 12 is constructed as described with reference to FIGS. 1 and 2.

The electrical connecting line 10 is in this case embodied in the manner of a winding having two turns 13 and 14, in which a loop 15 is guided around the one fastening apparatus 11, which loop has its beginning 16 as the (inner) turn 13 in the region of the further fastening apparatus 12. The loop 15 transitions as a further loop 17 in the region of the further fastening apparatus 12 and then runs to the one fastening apparatus 11. This is adjoined by an additional loop 18 here that runs around in the one fastening apparatus 11, so as then to terminate at its end 19 in the further fastening apparatus 12.

In other words, the one loop 15 and the additional loop 18, in its bent region, are positioned in the fastening apparatus 11 and/or fastened to the fastening apparatus 11. The further loop 17, in its bent region, is positioned in the further fastening apparatus 12 and/or fastened to the further fastening apparatus 12. One loop end of the further loop 17 adjoins one loop end of the one loop 15 and the other loop end of the further loop 17 adjoins a loop end of the additional loop 18. The loop ends of the two loops are positioned in the further fastening apparatus 12 and/or fastened to the further fastening apparatus 12.

In the electrical connecting line 10, the number of turns may be selected depending on the respective loading of the electrical connecting line 10. In the event of loading that is not very high, it may be enough to use just one endless turn in which—with reference to FIG. 3—only one loop 15 is used that is closed by the further loop 17.

In the event of higher loading of the electrical connecting line 10, the embodiment according to FIG. 3 comes into effect. In the event of very high loading of the electrical connecting line, additional turns may also be used.

1-34. (canceled)

35. A rail vehicle, comprising:
an electrical connecting line being a rail vehicle earthing line, said electrical connecting line having one end constructed as at least one loop;
said at least one loop having two loop ends forming another end of said connecting line; and
a fastening apparatus disposed at said one end of said connecting line.

36. The vehicle according to claim 35, wherein said electrical connecting line is configured to conduct a current flowing from said other end of said electrical connecting line through said electrical connecting line and through said two loop ends to said fastening apparatus.

37. The vehicle according to claim 35, wherein said at least one loop has a bent region at least one of positioned in or fastened to said fastening apparatus.

38. The vehicle according to claim 34, which further comprises a further fastening apparatus, said two loop ends of said at least one loop being at least one of positioned at said other end of said connecting line in said further fastening apparatus or fastened to said further fastening apparatus.

39. The vehicle according to claim 35, which further comprises a further fastening apparatus, said connecting line forming a further loop at said other end of said connecting line in a region of said further fastening apparatus.

40. The vehicle according to claim 39, wherein said further loop has a bent region being at least one of positioned in said further fastening apparatus or fastened to said further fastening apparatus.

41. The vehicle according to claim 40, wherein said further loop connects said two loop ends of said at least one loop to one another.

42. The vehicle according to claim 40, wherein:
said at least one loop includes one loop and an additional loop each having two respective loop ends;
said further loop has two loop ends;
one of said two loop ends of said further loop adjoins one of said two loop ends of said one loop; and
another of said two loop ends of said further loop adjoins one of said two loop ends of said additional loop.

43. The vehicle according to claim 40, wherein said at least one loop includes one loop and an additional loop, and said additional loop has a bent region being at least one of positioned at one end of said connecting line in said fastening apparatus or fastened to said fastening apparatus.

44. The vehicle according to claim 35, which further comprises a further fastening apparatus, said fastening apparatus and said further fastening apparatus each being formed of two respective conductive plates, said loops being fastened between said conductive plates.

45. The vehicle according to claim 44, wherein said conductive plates of said fastening apparatuses have mutually flush bores formed therein for receiving a fastening bolt.

46. The vehicle according to claim 44, wherein:
said conductive plates of said fastening apparatuses are each formed contiguously in a U-shape, or
said conductive plates of said fastening apparatuses are each formed contiguously in a tubular shape, or
each of said conductive plates and said loops respectively received by said conductive plates are crimped, clamped, welded or pressed.

47. The vehicle according to claim 35, wherein:
said electrical connecting line is formed of a flat-band conductor, or
said electrical connecting line is formed of a round material or a rope.

48. The vehicle according to claim 35, wherein the rail vehicle is an electric locomotive and said earthing line is an earthing rope.

49. The vehicle according to claim 35, wherein said electrical connecting line is configured to conduct a short-circuit current flowing from said other end of said electrical connecting line through said electrical connecting line and through said two loop ends of said at least one loop to said fastening apparatus.

50. The vehicle according to claim 35, wherein said electrical connecting line is configured to conduct a short-circuit current flowing from said one end of said electrical connecting line through said electrical connecting line and through said two loop ends of said at least one loop to said other end of said connecting line.

51. A method for earthing a rail vehicle, the method comprising the following steps:
providing an electric earthing line having one end and another end;
providing a fastening apparatus at the one end of the earthing line;
configuring the earthing line with at least one loop at the one end; and
providing the at least one loop with two loop ends forming the other end of the earthing line.

52. The method according to claim 51, which further comprises earthing an electric locomotive as the rail vehicle, and using an earthing rope as earthing line.
